(19) United States
(12) Patent Application Publication
(10) Pub. No.: US 2019/0228614 A1
(43) Pub. Date: Jul. 25, 2019

(54) AN APPARATUS, SYSTEM AND METHOD FOR DISPENSING ARTICLES

(71) Applicant: GENIEAGENT PTE. LTD., Singapore (SG)

(72) Inventor: Renzhi HUANG, Singapore (SG)

(21) Appl. No.: 16/331,111

(22) PCT Filed: Sep. 5, 2017
(86) PCT No.: PCT/SG2017/050442

§ 371 Date: Mar. 6, 2019

(30) Foreign Application Priority Data
Sep. 6, 2016 (SG) 10201607415W

(51) Int. Cl. G07F 17/42; G07F 17/00

(52) U.S. Cl. CPC G07F 17/42; G07F 17/3251; G07F 17/0014

(57) ABSTRACT

Disclosed herein is a dispensing apparatus for dispensing at least one of an identification device and an article related to an event, the dispensing apparatus comprising: a storage unit storing and allowing dispensing of identification devices stored therein, an input module configured to receive an input from a user, a processor in electronic communication with the input module, the electronic processor processing the input and generating user data, the processor authenticating a user as an event participant based on at least the user data, an encoding module configured to encode the identification device with the user data to associate the identification device with the user and associate the identification device with the same event, following successful authentication of the user as an event participant, the storage unit including an opening via which the identification device can be dispensed from the storage unit in order to allow a user to retrieve the identification device from the apparatus. The dispensing apparatus may also include a printer adapted to print custom information onto one or more articles to be dispensed.

### FIELD OF THE INVENTION

The invention relates generally to an apparatus, system and method for dispensing articles. More particularly, but not exclusively, the present invention relates to an apparatus system and method for encoding identification devices and dispensing articles (including the encoded identification devices) related to an event such as but not limited to a sporting event.

### BACKGROUND

Events are ubiquitous in modern society in order to provide people with sporting and/or social outlets. There are different types of events that are held every day. Sports events are one type of event that are commonly held. In particular race events such as marathons, half marathons, “iron man” races or cycle races are some examples of commonly held race events. Race events can be for profit events or can be charity events.

For race events such as for example a marathon, each participant (i.e. user) is typically pre-assigned an identification device for the race, such as for example a Radio frequency identification (RFID) device. The RFID device (such as a RFID tag, label, or chip, or an article containing an RFID tag, label, or chip) is associated with each user, such that each user has their own RFID device. The RFID device may include a unique user identifier associated with each user (such as for example the user's race number), and can be used to track the timing results of the user via RFID detection at the timing mat on the event day. These identification devices are pre-allocated to a user once a user has registered for an event, such as a marathon. A user typically wears their RFID device during the event.

Such pre-assignment of the identification devices e.g. an RFID device poses several limitations. The user has to register for the race event by a certain cut-off date so that there is sufficient time for the pre-assignment of the identification device to be completed after the cut-off date. The pre-assignment of the identification device to the user is usually done manually, leaving room for human error. The manual assignment of identification devices also requires additional event staff and their time and can add to the costs.

In this specification where reference has been made to patent specifications, other external documents, or other sources of information, this is generally for the purpose of providing a context for discussing the features of the invention. Unless specifically stated otherwise, reference to such external documents or such sources of information is not to be construed as an admission that such documents or such sources of information, in any jurisdiction, are prior art or form part of the common general knowledge in the art.

In addition to identification devices, certain articles are also provided to participants that are associated with the event, such as for example a race pack.

### SUMMARY OF THE INVENTION

It is an object of at least one of the preferred embodiments of the present invention to provide an apparatus, system and method for dispensing an article that overcomes, or at least partially ameliorates some of the abovementioned disadvantages or which at least provides the public with a useful choice.

In a first aspect the present invention may be said to be a system for encoding RFID devices and dispensing articles, comprising:

a storage module for storing RFID devices and other articles;

an input module for receiving user input;

a processing module for generating user data based on the received user input;

an encoding module for encoding the generated user data onto one or more RFID devices stored in the storage module; and

one or more dispensing modules for dispensing one or more encoded RFID devices and one or more other articles stored in the storage module, wherein the one or more encoded RFID devices is matched with the one or more other articles prior to dispensing.

Preferably the system is a vending machine.

Preferably the generated user data which is encoded onto the one or more RFID devices is a race number or some other data which uniquely identifies a user in a race event.

Preferably the system also includes:
a printer,
the printer receiving custom user information from at least one of the processor and the input module, and
the printer printing the custom user information on one or more of the articles prior to dispensing the one or more articles.

Preferably the one or more dispensing modules can receive one or more articles with custom user information printed thereon by the printer,
the one or more dispensing modules are able to dispense the one or more articles after printing the custom information on one or more of the articles

Preferably the printer receives at least one of the one or more articles from the storage module prior to printing.

Preferably the system further comprises an event server arranged in electronic communication with the processing module and storing event,
the event server storing event information,
one of the processing module and the event server is configured to authenticate a user as a participant of an event by comparing the user data with event information stored on the sever.

Preferably the event information comprises at least one of an event date, event name, registered participant information and event type.

Preferably the user data comprises at least one of a user name, user age, user garment size, and user shoe size.

Preferably the user is authenticated by checking if a user name corresponds to the registered participant information.

Preferably the input module comprises at least one of screen and a reader for reading at least one of a code and a Near Field communication device and a EID (such as an RFID) and a physiological feature.

Preferably the reader is adapted to scan a code to receive scan data,
the processor configured to extract the user data from the received scan data and the processor adapted to communicate with the event server after extracting user data,
the processor or event server authenticating the user as an event participant based on the user data and the event information stored on the event server.

Preferably the input module comprises a payment unit, wherein the payment unit can facilitate electronic payment receipt for an event from a user.

In a second aspect the present invention may be said to be a method for encoding and dispensing RFID devices in a system, the method comprising:
generating user data based on user input entered into the system;
encoding the generated user data onto one or more RFID devices stored in a storage module of the system; and
dispensing the one or more encoded RFID devices.

In a further aspect the present invention may be said to be a dispensing apparatus for dispensing at least one of an identification device and an article related to an event, the dispensing apparatus comprising:
a storage unit storing and allowing dispensing of identification devices stored therein,
an input module configured to receive an input from a user,
a processor in electronic communication with the input module, the electronic processor processing the input and generating user data,
the processor authenticating a user as an event participant based on at least the user data,
an encoding module configured to encode the identification device with the user data to associate the identification device with the user and associate the identification device with the same event, following successful authentication of the user as an event participant,
the storage unit including an opening via which the identification device can be dispensed from the storage unit in order to allow a user to retrieve the identification device from the apparatus.

Preferably the storage unit can also store and allow the dispensing of the article related to the event via an opening in the storage unit to allow the article to be retrieved from the apparatus following successful authentication of the user as an event participant.

Preferably the article and the identification device are both associated with the user and the event (and are preferably dispensed simultaneously following successful authentication of a user as an event participant.)

Preferably the storage unit is configured to store and allow dispensing of one or more identification devices, and one or more articles (preferably following encoding of the identification device), via an opening in the storage unit to allow retrieval from the apparatus following successful authentication of the user as an event participant, and wherein the one or more identification devices being dispensed following encoding of the identification device.

Preferably the dispensing apparatus may further comprise:
a printer adapted to receive custom user information from the input module or receive custom user information from the input module which is derived from the reader, and;
the printer able to print the custom user information onto one of the one or more articles to be dispensed.

Preferably the storage unit including an opening via which the one or more articles including the custom user information printed thereon, can be dispensed from the storage unit in order to allow a user to retrieve the identification device from the apparatus

Preferably the storage unit comprises a first receptacle for storing the one or more identification devices.

Preferably the storage unit comprises a second receptacle for storing the one or more articles, the second receptacle and the first receptacle are separated from each other.

Preferably the first receptacle and the second receptacle are each at least in part defined by a plurality of walls.

Preferably the apparatus further comprises a dispenser in communication with the storage unit such that the dispenser can receive one or more of an identification device or an article, wherein the dispenser comprises a retrieval zone and an opening providing access to the retrieval zone, the retrieval zone able to receive one or more of the identification device and/or article from the storage unit for retrieval by a user.

Preferably the dispenser comprises a closure, the closure moveable between a first position and a second position wherein the closure closes the opening in the first position and the closure allows passage of a said identification device and/or article from the storage unit to the retrieval zone via the opening in the second position.

Preferably the processor communicating with an event server that stores event information, the processor authenticating a user as a participant of the event by comparing the user data with the stored event information.

Preferably the processor authenticates the user as an event participant, if the user data matches the event information.

Preferably the event information comprises at least one of an event date, event name, participant information and event type.

Preferably the user performs a registration process through the input module to transmit the participant information to the event server.

Preferably the event server comprises an event database that stores the event information.

Preferably the input module comprises a scanning unit, the scanning unit configured to scan a user identifier to generate the input, and the processor in communication with the scanning unit such that the processor receiving the input and processing the input to generate the user data.

Preferably the user identifier is an optically readable identifier, the scanning unit is configured to scan the identifier to generate the input.

Preferably the apparatus further comprises:
a payment module,
the payment module connecting to an electronic gateway such that a user can execute an electronic payment for an event at the payment module.

Preferably the input module comprises a user interface, the user interface presenting a list of one or more events, the user selecting one or more of the events presented on the user interface, the user interface receiving a selection of an event from the user.

Preferably the processor can authenticate a user as an event participant for the selected event.

Preferably the dispenser can dispense the one or more articles associated with the selected event.

Preferably the encoding module is adapted to encode the one or more identification devices with the user data and the selected event such that the one or more identification devices are associated with the user for the selected event.

Preferably the one or more identification devices are a radio frequency identification (RFID) device.

Preferably the RFID device is a RFID tag that is able to be encoded with event data related to the selected event and user data to associate the RFID tag with the user for the selected event.

Preferably the identification device is used to track user performance in the event.

Preferably the identification device is used as a timing device to track the time taken for the user to complete the event.

Preferably the user data comprises at least one of a user name, user age, user shirt size, user shoe size or any other suitable user data.

Preferably the custom user information comprises at least one of a user's name, a user's nickname, a custom user name, a user's event number or a user's team name.

Preferably the at least one article comprises a race pack including at least one of a clothing item, a headwear item and a wearable device.

Preferably the printer is configured to print the custom user information on the clothing item provided as part of the one or more articles.

Preferably the clothing item is a bib or a shirt.

Preferably the apparatus further comprises:
a selection module arranged in electronic communication with the processor,
the selection module selecting the at least on article from the storage unit based on the user data generated by the processor,
the selection module providing the selected article(s) from the storage module to the opening via which the at least one article can be dispensed from the storage unit in order to allow a user to retrieve the identification device from the apparatus.

Preferably the selection module selects a textile garment that corresponds to a user size defined in the user data.

Preferably wherein the apparatus provides on location association of an identification device with a user for an event and dispensing of the identification device to the user.

Preferably the apparatus provides on location association of one or more articles with the user for an event and dispensing of the one or more articles to the user.

Preferably the event database stores the event information, the event server configured to extract event information from the event database and provide the event information to the processor for authentication of the user.

Preferably the apparatus is a vending machine.
In yet a further aspect the present invention may be said to be a system for distributing event related articles and event related identification devices, the system comprising:
one or more dispensing machines,
an event server in wireless communication with each of the one or more dispensing machines, the event server storing event information including an event and participants of the event,
at least one dispensing machine of the one or more dispensing machines configured to:
   receive an input from a user including an event selection,
   process the input to generate user data,
   authenticate the user as a participant of the selected event,
   encode an identification device with the user data following successful authentication,
   dispense the encoded identification device and one or more articles following successful authentication of the user, and wherein the identification device and the one or more articles is associated with the user and the selected event.

Preferably the dispensing machine is an apparatus herein described.

Preferably the system comprises a plurality of dispensing machines that are geographically separated such that each dispensing machine is located at a separate geographical location as compared to the dispensing machines.

In still a further aspect the present invention may be said to be a method for dispensing at least one of an identification device and an article related to an event, the method comprising
storing one or more identification devices
receiving an input from a user,
processing the input to generate user data,
authenticating the user as a participant of the event,
encoding an identification device with the user data following successful authentication,
dispensing the encoded identification device following successful authentication of the user, and wherein the identification device is associated with the user and the selected event

Preferably the method comprises:
storing an article related to the event
dispensing the article following authentication of the user as a participant of the event.

Preferably the article and the identification device are both associated with the user and the event.

Preferably the method comprises
storing a plurality of identification devices and a plurality of articles,
dispensing one of the plurality of identification devices following encoding of the one of the plurality of the encoding devices and dispensing one or more of the plurality of articles following encoding the identification device.

Preferably the method also comprising:
printing the custom user information onto one of the one or more articles, and
dispensing the one or more articles with the custom user information printed thereon.

Preferably the method also comprises
communicating with an event server that stores event information,
authenticating a user as a participant of the event by comparing the user data with the stored event information.

Preferably a user is authenticated as an event participant if the user data matches the event information.

Preferably the event information comprises one or more of an event date, event name, participant information and event type.

Preferably the method comprises registering a user as a participant for an event through the input module and transmitting the participant information to the event server.

Preferably the method comprising:
scanning a user identifier and generating the input,
processing the input to generate the user data.

Preferably the method comprising:
connecting to an electronic gateway,
executing an electronic payment for an event at a payment module.

Preferably the method comprises the steps of presenting a list of one or more events available for participation by a user, and receiving an event selection from the user from the one or more events.

Preferably the method comprises the steps of authenticating a user as an event participant for the selected event.

Preferably the method comprises the steps of the step of dispensing the one or more articles associated with the selected events.

Preferably the method comprises the steps of encoding the one or more identification devices with the user data such that the identification device is linked to a user and linked to the selected event.

Preferably the one or more identification devices are an RFID (radio frequency identification) device that is used to track user performance in an event.

Preferably the user data comprises at least one of a user name, user age, user shirt size, user shoe size or any other suitable user data.

Preferably the custom user information comprises at least one of a user's name, a user's nickname, a custom user name, a user's event number or a user's team name.

Preferably the one or more articles comprises a race pack including one or more of a clothing item, a headwear item, a wearable device.

Preferably the step of printing custom user information on to the clothing item provided as part of the one or more articles.

Preferably the method provides on location association of an identification device with a user for an event and dispensing of the identification device to the user.

Preferably the method provides on location association of one or more articles with the user for an event and dispensing of the one or more articles to the user.

According to another aspect of the present invention, there is provided a system for encoding RFID devices and dispensing articles, comprising the following components:

a storage module for storing RFID devices and other articles; an input module for receiving user input;

a processing module for generating user data based on the received user input;

an encoding module for encoding the generated user data onto one or more RFID devices stored in the storage module; and

one or more dispensing modules for dispensing one or more encoded RFID devices and one or more other articles stored in the storage module, wherein the one or more encoded RFID devices is matched with the one or more other articles prior to dispensation.

According to a further aspect of the present invention, there is provided a system for encoding RFID devices and dispensing articles (including the encoded RFID devices) based on user input.

According to yet another aspect of the present invention, there is provided an apparatus for encoding RFID devices and dispensing articles (including the encoded RFID devices) based on user input.

The storage unit comprises one or more receptacles configured to retain identification devices and/or one or more articles. The storage unit comprises a plurality of receptacles for retaining identification devices such as RFID tags or GPS tags or NFC tags and/or articles such as a race pack or shirt or bib.

The dispensing comprises an openable door that is configured to hinge between an open and closed position. The door preferably allows access to the storage unit and/or to one or more receptacles in the storage unit.

The dispensing apparatus comprises a lock mechanism coupled to the door, the lock mechanism configured to lock the door in a closed position. The lock is an electromechanical lock or an electronic lock that is controlled by the processor.

The storage unit may comprise a trap door or a flap that allows at least one or more articles to drop into the printer for printing.

Further details and advantages of the invention will become apparent from a consideration of the drawing and subsequent detailed description of the invention.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting. Where specific integers are mentioned herein which have known equivalents in the art to which this invention relates, such known equivalents are deemed to be incorporated herein as if individually set forth.

As used herein the term ‘(s)’ following a noun means the plural and/or singular form of that noun.

As used herein the term ‘and/or’ means ‘and’ or ‘or’, or where the context allows both. The invention consists in the foregoing and also envisages constructions of which the following gives examples only.

The term ‘comprising’ as used in this specification and claims means ‘consisting at least in part of’. When interpreting statements in this specification and claims which include the term ‘comprising’, other features besides the features prefaced by this term in each statement can also be present. Related terms such as ‘comprise’ and ‘comprised’ are to be interpreted in a similar manner.

The term “module” as used in this specification and claims means ‘an operable or controllable hardware unit that comprises appropriate circuitry or a hardware unit comprising appropriate circuitry and one or more of appropriate firmware or software being stored and executed by the hardware unit’. When interpreting statements in this specification and claims which include the term “module”, the module can be a pure hardware electronic unit or a hardware electronic unit that includes firmware or software or a combination thereof.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7) and, therefore, all sub-ranges of all ranges expressly disclosed herein are hereby expressly disclosed. These are only examples of what is specifically intended and all possible combinations of numerical values between the lowest value and the highest value enumerated are to be considered to be expressly stated in this application in a similar manner.

### BRIEF DESCRIPTION OF THE FIGURES

The present invention will now be described by way of example only and with reference to the accompanying figures in which:

FIG. 1a shows a diagram of a system for dispensing an article including a plurality of dispensing machines and an event server.

FIG. 1b shows a schematic of the event server and its internal components.

FIG. 2 shows a diagram of one embodiment of a dispensing apparatus for dispensing an article.

FIG. 3 shows a diagram of an embodiment of a dispensing apparatus for dispensing an article.

FIG. 4 shows a view of the externally visible components of the dispensing apparatus shown in FIG. 3.

FIG. 5 shows a further embodiment of a dispensing apparatus for dispensing an article.

FIG. 6 shows a flow chart of a method user interaction with a dispensing apparatus.

### DETAILED DESCRIPTION OF THE INVENTION

The invention relates generally to an apparatus, system and method for dispensing articles. More particularly but not exclusively the present invention relates to an apparatus system and method for encoding identification devices and dispensing articles (including the encoded identification devices) related to an event. The dispensing of articles and/or encoding of identification devices may be performed based on a user input.

Exemplary embodiments of the present invention are described herein with reference to the accompanying figures. The invention is not, however, limited to the described exemplary embodiments.

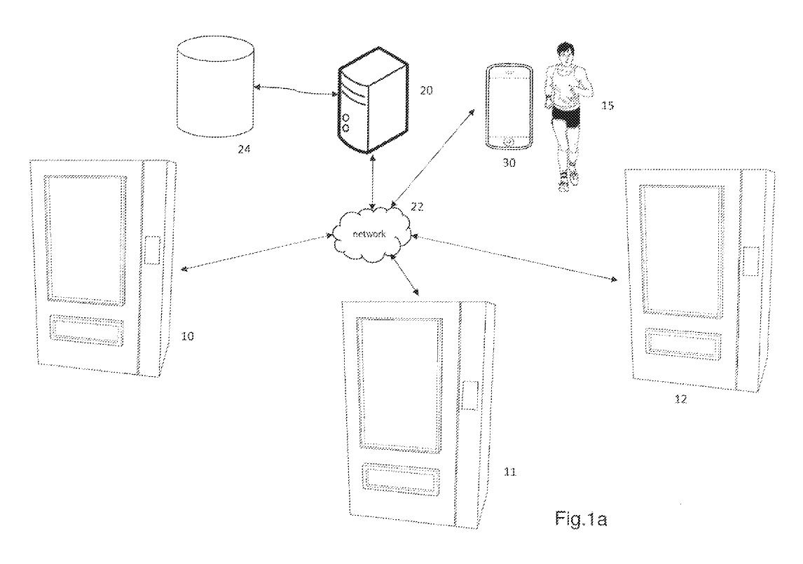

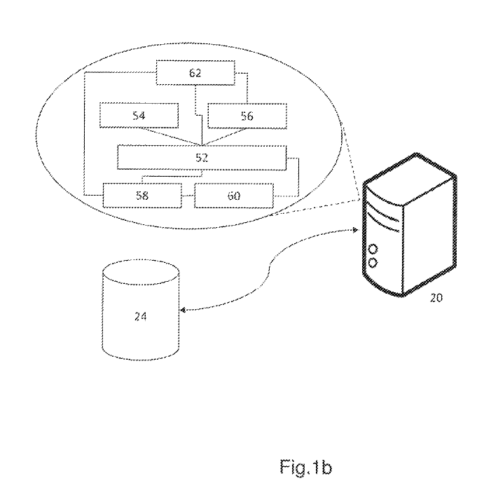

FIG. 1 shows an embodiment of a system 1 for distributing event related articles and event related identification devices to a user 15. The user may be an event participant such as a participant for a running race for example.

The system 1 provides a convenient and flexible manner to allow an event participant 15 (i.e. user) to retrieve a user associated identification device and/or an article related or associated with an event.

The system 1 comprises one or more dispensing machines 10 (i.e. dispensing apparatuses) and preferably an event server 20 if more than one dispensing machine is utilised. In the illustrated embodiment of FIG. 1 the system 1 preferably comprises a plurality of dispensing machines 10, 11, 12 that are geographically distributed from each other. The event server 20 (i.e. event server) may likewise be separated or be contained at one of the dispensing machines. For example each dispensing machine 10, 11, 12 is preferably situated at different locations within a city or different locations within a suburb or generally in different locations.

The dispensing machines 10, 11, 12 may be wirelessly coupled to the event server 20 via a suitable communications network 22. Preferably the communication network 22 is a wireless communication network that allows wireless communication between two or more devices or components within or coupled to or associated with network 22. The network 22 provides a communication medium or pathway. The communication network 22 may any suitable telecommunication or mobile communication network. For example the communications network 22 may be a 4G or 3G network or a GSM network or a cellular network or any suitable mobile communication network. Alternatively the communications network 22 may be any other suitable wireless communication network. Alternatively the network could be at least partially a wired network or a mixture of a wired and wireless network.

The event server 20 is configured for two way communication with each of the dispensing machines 10, 11, 12 such that the event server 20 can send and receive information from each dispensing machine 10, 11, 12. The dispensing machines may be vending machines that are configured to dispense an identification device and/or an article associated with an event e.g. a race event. The user 15 can retrieve the identification device and/or an article from the dispensing machine, prior to the start of the event.

The server 20 may also include an event database 24 that may be stored in a memory unit of the server or may be a remote database or a cloud based database. The event database may store event information, in particular but not exclusively the event name, date and participant information. The event database 24 may be any suitable database such as a relational database. Further the event server 20 may be arranged in a sever client relationship with the dispensing machines 10, 11 and 12, wherein the dispensing machines are the client devices.

The event information may be provided to the event server 20 (i.e. event server 20) from an event organiser. In one example the event information may be provided to the event server 20 by an event organiser server. The event information is provided in any suitable electronic format. The event organiser can execute an event loading process that transmits the event information to the event server 20 and allows the event server 20 to verify (i.e. authenticate) a user as an event participant. The event loading process may comprise creating an event to be stored at the event server 20 and supplying the event information associated with the event to the event server 20. The event server 20 can store event information associated with multiple events.

A user 15 can also have a user device 30 owned by the user. The user device 30 is linked with the user. The user device 30 is preferably a portable electronic device. For example the user device 30 may be mobile device such as for example a smartphone or a mobile phone or tablet or 2 in 1 tablet. Alternatively the user device 30 may be a laptop or another portable electronic device. The user device 30 is configured to communicate with the event server 20 using any suitable communication protocol. In the illustrated example the user device 30 is configured to communicate with the server via the network 22. The

The system 1 can allow on site or real time retrieval of an identification device and/or articles associated with a race event by a user, once the dispensing machine authenticates a user as an event participant. The identification device is preferably encoded with user data and the identification device is linked to or associated with the user 15. The identification device may be used by the user to track the position of the user in an event and/or as a timer or part of a timing system to record the start and finish time of the user. The identification device may be used as an access device/pass/ticket to the event site. Other uses are also envisaged.

The event server 20 may be configured to host an event registration website that can be provided to any of the client devices e.g. the mobile user device 30 or one of the dispensing machines 10, 11, 12. Preferably the event server 20 provides a list of events, loaded at the event server 20, to the dispensing machines. The dispensing machines 10, 11, 12 can present a list of events to the user for selection. The user can select an event and the dispensing machine can execute an authentication machine to verify the user is a participant for the particular event.

FIG. 1b shows a schematic diagram of exemplary form of the event server 20 and its internal components. The event server 20 comprises suitable components necessary to receive, store and execute appropriate computer instructions. The components may include a processing unit 52, read only memory (ROM) 54, random access memory (RAM) 56, and input/output devices such as disk drives 58, input devices 60 such as an Ethernet port or a USB port etc. and a communications link 62. The event server 20 includes instructions that may be included in ROM 54 or RAM 56 or disk drives 58 and may be executed by the processing unit 52.

There may be provided a plurality of communications links 62 which may variously connect to one or more computing devices such as the user device 30 or the dispensing machines 10, 11, 12 or an event organiser computing device (e.g. an event organiser server) or other servers, personal computers, wireless or handheld computing devices. At least one communication link 62 is connected to an external computing network e.g. network 22 through a telephone line or other type of communication link.

The disk drives 58 may include solid state drives, hard disk drives, optical drives or magnetic tape drives. The event server 20 may use a single disk drive or multiple disk drives. The server 20 may also have a suitable operating system which resides on a disk drive 58 or in the ROM 54 of the server 20. The event database 24 resides on a disk or other storage device which is arranged to store event information or other information. The database 24 may be stored on a disk drive of the event server 20 or stored in a remote location accessible by the server 20. The database 24 may be a relational database, in one example

Exemplary embodiments of the dispensing machines (i.e. dispensing apparatuses) will be described in more detail below.

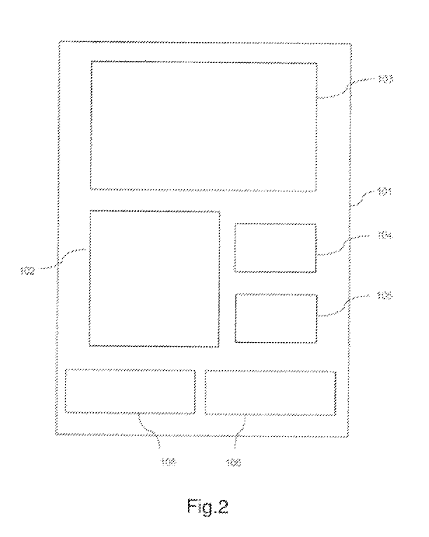

FIG. 2 illustrates an exemplary embodiment of a dispensing apparatus 101 for dispensing an article and/or an identification device. The dispensing apparatus 101 may be used as part of the system 1 for encoding and dispensing an identification device and/or dispensing an article for an event. Each of the dispensing apparatus 10, 11, 12 in the system shown in future 1 may be similar in structure and operation to the dispensing apparatus 101.

In the embodiment shown in FIG. 2 the dispensing apparatus acts 101 as a vending machine or kiosk. It may comprise of a storage module 102, an input module 103 for receiving user input, an encoding module 104 for encoding data onto each identification device, a processing module 105, and one or more dispensing modules 106 for dispensing articles. In the illustrated embodiment the identification device may and EID (Electronic Identification Device) such as a Radio Frequency Identification (RFID) devices.

### Alternatively

The exemplary embodiment with reference to FIG. 1 will be described with reference to RFID devices as the format of the identification device. RFID devices are used in an event, in particular a race event, such as for example a marathon or bicycle race as a timing element to help record the finish time of the user. The RFID device may also be used to track and/or locate the user on the race course. During an event, each user carries their own RFID device with them for a particular event. The RFID device is generally associated with a particular event and is also generally associated with a single user.

The storage module 102 contains a plurality of RFID devices (such as RFID tags/labels/chips, or articles containing RFID tags/labels/chips). It may also contain other articles that may be presented as a race pack that is associated with an event and may be distributed in conjunction with a race event. The race pack may include items such as a race bib or t-shirt this is associated with or distributed in conjunction with a race event. The article(s) in the race pack may be packaged or may be separate article(s) not packaged.

The storage module 102 may also contain items which are not associated with a race event such as snacks, energy gels, protein bars and/or drinks. It may also contain printed material such as advertising and/or instructions for the user about the event. These may be give-aways or be additional purchases for the user. In another example the race pack may also include such additional items.

The input module 103 may be a touchscreen, a barcode reader, an alphanumeric keyboard, some other input device, or any combination thereof. Preferably the input module 103 comprises at least a screen to present information to the user. The user interface is preferably a touch screen that allows input from users and may present information as an output. The input module 103 preferably also comprises a reader such as an optical code scanner such as barcode reader or a QR code reader.

A user may register for a race event by various means (e.g by submitting an online registration form through a website or by submitting a physical registration form at a designated venue), and obtain unique registration information (such as a booking number or booking reference). The registration information may also or instead be provided to the user in the form of a barcode such as a Universal Product Code (UPC) barcode or Quick Response (QR) barcode, which may be printed onto a piece of paper or be displayed on the user's mobile phone or other user mobile device such as a tablet.

To collect his/her race pack (i.e. a collection of items associated with the race event, such as the RFID device and race bib or t-shirt), the user may manually enter his/her registration details into the input module 103 of the machine 101. Alternatively or in addition the user may also scan his/her race registration barcode at the input module 103 so that his/her registration details are captured by the machine 101.

Thereafter, the processing module 105 processes the user's registration details and may retrieve or generate user data associated with the user (such as a race number or some other data which uniquely identifies the user in the race event). The encoding module 104 may encode user data onto one or more RFID devices stored in the storage module 102. The processing module 105 is preferably configured to associate the one or more encoded RFID devices with the rest of the items in the user's race pack (such as the user's race bib bearing the user's race number or t-shirt with the user's correct size), prior to presenting the entire race pack or items individually, for retrieval by the user from the apparatus. After the association is completed, the dispensing module(s) 106 can dispense the user's race pack for retrieval from the apparatus by the user. The item(s) and the identification device presented for retrieval (preferably as a race pack) are associated with the user and the particular race event.

In another embodiment of the invention, the user may register for the race event directly at the machine 101, by for example entering his/her details into the input module 103. Thereafter, the processing module 105 may process the user's registration details and generate user data associated with the user (such as a race number or some other data which uniquely identifies the user in the race event). The encoding module 104 may encode the generated user data onto one or more RFID devices stored in the storage module 102. The processing module 105 is configured to associate or match the one or more encoded RFID devices with the rest of the items in the user's race pack (such as the user's race bib bearing the user's race number or t-shirt with the user's correct size), prior to dispensation of the entire race pack. Preferably after the association is completed, the dispensing module(s) 106 will dispense the user's race pack for collection by the user. The race pack and the identification device (RFID device) are associated with the user and the particular race event when collected. Prior to interaction of the user with the machine, the items to be dispensed are stored but not customised.

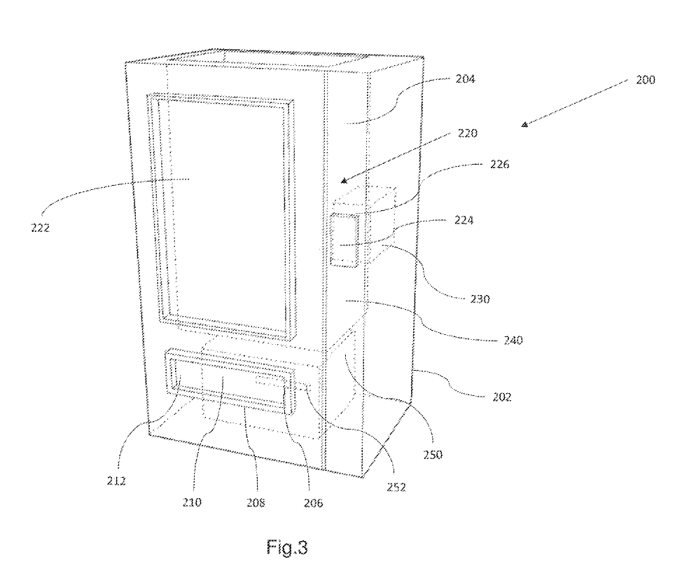

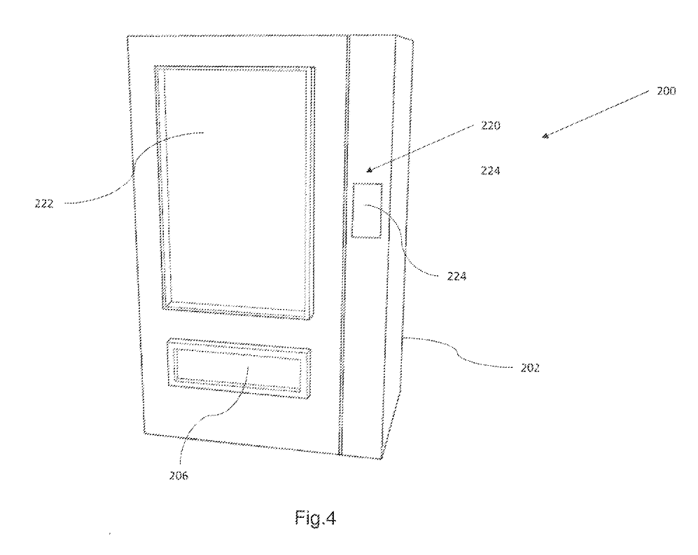

FIGS. 3 to 4 illustrate an embodiment of a dispensing apparatus 200 for dispensing at least an article. The dispensing apparatus 200 may be used as part of the system 1 for encoding and dispensing an identification device and/or dispensing an article for an event. Each of the dispensing machines 10, 11, 12 may be similar in structure and operation to the dispensing apparatus 200. Preferably the dispensing apparatus 200 is configured to dispense at least one of an identification device and an article related to an event. The event may be any suitable event such a race event.

Broadly speaking the dispensing apparatus 200 may comprise a storage unit storing allowing dispensing of an identification device, an input module configured to receive an input from a user, a processor in electronic communication with the input module, the electronic processor processing the input and generating user data, the processor authenticating a user as an event participant based on at least the user data, an encoding module configured to encode the identification device with the user data to associate the identification device with the user and associate the identification device with the event, following successful authentication of the user as an event participant, and a dispenser or a dispensing opening of the storage unit dispensing the encoded identification device from the storage unit following encoding of the identification device.

The identification device may be any suitable electronic device such as an RFID tag, chip or label that is used to record a finish time or record both a start and finish time of the user, for an event. Alternatively the identification device may be any other suitable radio frequency based or electromagnetic radiation device such as RuBee tag, chip or label. In a further alternative form the identification device may be a wrist band with an optical code such as a QR code, or another article with an optical code on it. In a further example the identification device may be a scannable or readable optical code e.g. a barcode or a QR code that may be printed directly on one of the dispensed articles e.g. a race bib or shirt.

The identification devices are preferably used in an event, in particular a race event, such as for example a marathon or bicycle race as a timing element to help record the finish time of the user. The identification device may also be used to locate the user on the race course. Each user has an identification device that is associated (e.g. linked only) with them for a particular event. The identification device is generally related to a particular event and is also generally associated with a single user by encoding the identification device with user data. Once user data is encoded into the identification device, the identification device becomes associated with the user. The identification device may also be encoded with event information to associate or link the identification device with the particular event.

The dispensing apparatus 200 is preferably a vending machine configured to dispense an identification device and an article related to an event. The dispensing apparatus 200 comprises a housing 202 that preferably retains all the components of the dispensing apparatus 200. The housing 202 is preferably made of a solid and robust material such as a metal or a rigid plastics material. The housing 202 comprises a plurality of walls that enclose a hollow space, wherein the hollow space includes a plurality of components.

Referring to FIGS. 3 and 4 the dispensing apparatus 200 may comprise a storage unit 204, an input module 220, a processor 230, an encoding module 240 and an optional printer or printing module 250. FIG. 3 shows the internal components and FIG. 4 shows the externally visible components of the dispensing apparatus 200.

The storage unit 204 is configured to store one or more of the identification devices. The storage unit 204 may also store one or more articles related to the event. The identification devices may be any suitable electronic identification device (EID), such as for example an RFID device or a NFC chip or a GPS tracker. The identification device is preferably used to track the information of the user in an event such as for example track the location of the user in a race event or record start and finish times. The identification device may be a passive electronic identification device or an active electronic identification device configured to transmit and receive information.

Preferably the storage unit 204 retains RFID devices, such as for example RFID tags, labels or chips. The storage unit 204 may retain one or more articles such as a race pack, for a race event. The race pack may a clothing item (e.g. a bib or a shirt or singlet), a headwear item (e.g. a hat or headband), a wearable device or any other suitable race event articles. The one or more articles may also comprise other articles related to any other event. The article(s) are preferably packaged. Alternatively the articles they may not be packaged. The race pack may also contain printed material such as advertising material and/or instructions or last minute weather or safety information for the user about the event. The race pack i.e. article may also include products such as energy gel packs or protein bars or promotional products or tokens or gifts or event sponsor related products. The race pack is stored in the storage unit 204 and dispensed to the user.

The storage unit 204 may include an opening via which the identification device and/or other articles can be dispensed from the storage unit in order to allow a user to retrieve the identification device and/or the other articles. Optionally the storage unit 204 may include or allow passage there from to one or more receptacles or bins from which the identification device(s) and/or article(s) can be retrieved by the user. For example a first receptacle may be provided to present for retrieval, the one or more identification devices (RFID devices) and a second receptacle for the one or more articles related to the event.

Preferably a dispensing apparatus 200 is provided that may comprise a dispenser 206 in communication with the storage unit 204. The dispenser 206 can receive one or more of the identification devices and/or one or more of the articles related to an event. The dispenser 206 comprises a retrieval zone and an opening 208 providing access to the retrieval zone 210. The retrieval zone 210 is able to receive the one or more identification device and/or the article from the storage unit for collection or retrieval by a user.

Optionally the retrieval zone 210 may include an internal wall or divider that separates the retrieval zone or dispenser into multiple compartments or bins. Each bin or compartment may be associated with one of the identification device or article such that the identification device is dispensed, from the storage unit 204 into one compartment or bin and the article is dispensed into a separate compartment or bin.

The dispenser 206 may further comprise a closure moveable between a first position and a second position wherein the closure closes an opening in the first position. The closure may for example be able to isolate the storage unit 204 from the dispenser 206 or the retrieval zone 210. In the second position the closure allows passage of the identification device and/or the article from the storage unit 204 to the retrieval zone 210.

The dispenser 206 may also include a moveable door 212. Moving the door 212 to an open position allows the user access to the retrieval zone 210 or alternatively may allow access to a portion of the storage unit 204 to allow access to the appropriate articles to be retrieved by the user. The door 212 is preferably a sprung door that is biased to the closed position to protect articles and/or identification devices from unnecessary environmental damage or being taken by strangers.

FIGS. 3 and 4 shows an input module 220 configured to receive an input from a user. The input module 220 may comprise at least one of a user interface 222 and a reader 224. Preferably the input module 220 comprises a user interface 222 and a reader 224. The reader 224 is configured to scan a verification code or a NFC device or an electrical identification device e.g. RFID or a physiological feature or parameter of a user to identify the user. The code may be provided on the user device 30 or may be printed by the user.

The user interface 222 may include a screen that is presented on a user facing side (i.e. a front face) of the apparatus 200. The user interface 222 may cover a substantial portion of the front face of the apparatus 200. In one example the user interface 222 covers at least 33 percent of the front face of the apparatus 200. In one example the screen 222 has a height between 700 mm and 1100 mm, and width between 450 mm and 650 mm. More preferably the screen 206 has a height of about 1075 mm and a width of about 606 mm. The screen 222 is preferably a touch screen that allows a user to input information and also presents information to the user.

Alternatively the screen 222 may be small and located adjacent the reader 224, such as for example above or below the reader 224. As a further alternative the front face of the dispensing apparatus 200 may comprise a transparent glass pane or plastic pane that allows people to look at articles stored within a storage unit 204.

The reader 224 is configured to scan a code or a near field communication device or an electronic identification device (e.g. a separate RFID) or a physiological feature or parameter. The reader 224 may optionally comprise a computer vision unit or a camera in communication with a processor 230 to use computer vision to identify a user. The reader 224 may be a scanner for biometric scanning to identify the user. Preferably the reader 224 is configured to scan an optical code such as a barcode or a QR code (quick response code) or a UPC code (Universal Product Code) or another suitable visual code that carries information.

The processor 230 is preferably a suitable hardware processor that comprises suitable electronic circuitry. The processor 230 comprises suitable components necessary to receive, store and execute appropriate computer instructions. The processor 230 in one example is a computing device having a combination of hardware and software components to execute optical, or electronic or computer instructions.

The processor 230 may also comprise a local memory unit in communication with the processor. The memory unit may be flash memory or RAM that can act as a buffer or a cache to at least temporarily store some information. The processor 230 is configured to receive an input from the input module 220, process the input to generate user data (e.g. one or more of user name, race number, or some other data which uniquely identifies the user in the race event) and authenticate the user as an event participant based on at least one or more elements of the user data.

A user may register to attend an event. For example the user may register to take part in a race event. The user preferably registers via an online registration process through a website using a user mobile device 30 (shown in FIG. 1) or another suitable computing device or electronic device.

In one form the event server 20 may host a website and can provide the website to a client device e.g. a mobile user device 30 such that the user can register for an event via the event server 20. Alternatively the user may physically register by submitting a physical registration form at a designate venue. In an alternative configuration the registration process may be completed through the user interface 222 by keying in appropriate details of the user.

In one example the user 15 registers for an event as a participant with an event organiser. This can be an online registration process or a physical registration process. The event organiser sends event information including a list of participants to the event server 20. The event server 20 is configured to store the received event information within the event database 24 or in a suitable memory unit.

The user can input participant information for example user name, user shirt size and other suitable information required by the event organizer to register the user for the event. Registration details such as a booking number or booking reference and the participant information is transmitted to the user device post successful registration by the user.

The registration details may be embodied in the form of an optical code such as barcode or UPC code or QR code etc. The registration details are scan data. The scan data preferably includes an address to information stored at the event server 20. The user can scan the received code to generate scan data. The user preferably selects an event either by scanning the code or alternatively by manual selection through the touch screen 222. For example the interface 222 may be configured to present a list of events that a user can take part in. The user selects a specific event to take part in. The interface 222 is configured to prompt the user to enter the registration details that correspond to the registration performed by the user. In one example the user can scan the QR code or UPC code or other suitable optical code that embodies the registration details at the user interface. In one example the user can scan optical code at the reader 224. The reader 224 (i.e. input module) may generate scan data based on scanning the optical code.

The processor 230 is preferably configured to extract user data from the scan data and utilise the user data to authenticate the user as an event participant. The processor 230 is configured to communicate with the server 20 to verify that the user has registered i.e. the user is an event participant. The event server 20 preferably stores event information either in a memory unit or on an event database 24. The event information may include one or more of an event date, event name, participant information and event type. The user data may include one or more of data comprises at least one or more of a user name, user age, user shirt size, user shoe size or any other suitable user data. The user is preferably authenticated when the user data extracted by the processor matches at least parameter stored as part of the event information stored in the event server 22. In one configuration the touch screen 222 may be configured to present a series of selectable races, where the user may select one race and be authenticated for the selected race and receive an RFID device and/or a shirt or bib associated with the series.

The user can also collect one or more other articles associated with the event, such as a race pack. The race pack may include one or more of a clothing item, a headwear item, a wearable device or other items herein described. The article or articles may be dispensed packaged or unpackaged and where a plurality of articles are dispensed, they may be consolidated in a package or dispensed individually.

The articles/race pack may be dispensed for collection by the user, such as through the dispensing apparatus 200, after either manual input through the screen 222 or by reading (eg scanning) such as of a code e.g. a QR code presented by the user, to improve security.

The input module may also comprise a payment module 226. The payment module is preferably provided adjacent the reader 224 (or scanner). The payment module is configured preferably to connect to an electronic payment gateway such that the user execute an electronic payment for an event. The payment module 226 may be a bank card scanner or a credit card scanner to allow a user to pay registration fees for the event at the dispensing apparatus 200.

The apparatus 200 may further comprise an encoding module 240 that is in electronic communication with the processor 230. The encoding module 240 is configured to encode one or more identification devices with the user data that has been extracted from the participant information.

For example the processor 230 may access the event server 20 as part of the authentication process, but also download user data. Alternatively the user data is extracted from or provided from the server to the processor 230, as part of scanning an input e.g. a barcode or QR code.

The encoding module 240 is preferably configure to encode user data onto the identification device such that the then encoded identification device is linked or associated with a single user. The encoding module 240 comprises suitable hardware circuitry and may include software or firmware required for encoding identification devices. The processing module 230 is configured to match or associate the encoded identification device with one or more other articles e.g. a race pack, and wherein the processing module further configured to associate the encoded identification device and the race pack with a single user that has been correctly verified.

The apparatus 200 may also comprise a printer 250 located within the housing 202. The printer 250 may be controlled by the processor 230, but may alternatively be controlled on a separate device or computer. The printer 250 is preferably located adjacent the storage unit 204 and is preferably also located adjacent the dispenser 206 if provided. In the illustrated embodiment an opening 252 for printed material to pass through and be provided to the retrieval zone 212 in the apparatus 200. The retrieval zone 212 may be a tray that can be accessed by the user for collection of the article with custom information printed thereon. The printer 250 is configured to print custom information, e.g. a name or nickname or race number etc. onto an article such as a textile article such as a race bib. The printer 250 may be any suitable commercial printer. It is preferably of a kind capable of printing on a number of different articles. Once printed the printed articles are dispensed to the user.). Custom information may also be printed by the printer on paper to provide information or instructions to the user. It may display the course or change in course to be competed on in the event. It may show information about a team that the user is assigned to. It may display weather or hazard information that the user may need to be made aware of.

The dispensing apparatus 200 may also include a selection module (not shown for clarity) arranged in electronic communication with the processor 230. The selection module may be positioned within the storage unit 204 or at least is moveable into and out of the storage unit 204. The selection module is preferably a moveable arm that is controlled by the processor 230. The selection module selects one or more articles from the storage unit based on the user data generated by the processor 230, following authentication of the user as an event participant. For example the selection module may be configured to select and pick a shirt or bib that corresponds to the user's size defined in the user data and may correspond to the particular event selected by the user. The selection module provides the selected one or more articles (e.g. textile garments such as bibs or shirts) to the retrieval zone 212 or to the opening the storage unit 204 to subsequently allow retrieval by the user.

Preferably the processor 230 is configured to identify the type of article or articles to be dispensed based on the user data. For example the processor 230 is configured to identify the size of shirts or bibs to be dispensed and control a selection module to select the correct size of shirt or bib or select another article to be dispensed based on the user data. The processor 230 may also control the printer 250 to print custom information or print information based on the user data. In one example the processor 230 may identify the user as a female 5 km runner having a small shirt size from the user data. The processor 230 will control the storage unit 204, or at least the selection module to correctly select an article e.g. a race pack that includes a correct sized shirt or a correct sized shirt to be dispensed to the printer for printing custom information. The processor 230 may also control the printer 250 to input custom information but also information relating to the event the user is participating in (e.g. the 5 km race) onto the appropriate sized article. The processor 230 is configured to execute this process based on the user data that is identified.

In an alternative form the identification device may be an optical code that may be readable with an appropriate reader. In this alternative form the identification device may be a wrist band or a headband article with a printed optical code. The optical code may be pre-printed onto the wrist band or headband. The optical code (e.g. QR code) may be encoded with the user data (e.g. user name or race number or some other data which uniquely identifies the user in the event) as part of the encoding process. Alternatively the optical code (e.g. QR code) may be printed onto the article by the printer 250 as part of the encoding process. The printer may be provided with the user data by the processor 230. In a further alternative the identification device may be an optical code that may be printed onto the article (e.g. a race bib or shirt or headwear) as part of the encoding process, prior to any custom user information being printed thereon.

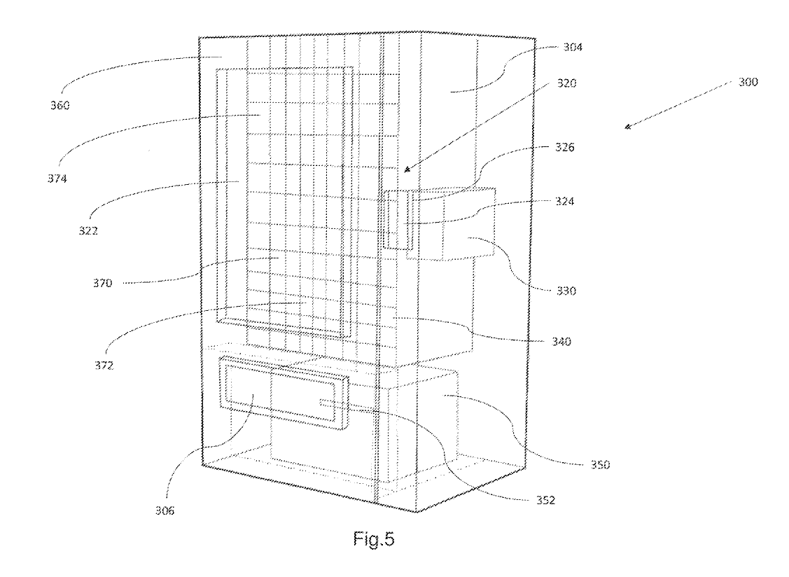

FIG. 5 shows an embodiment of a dispensing apparatus 300 for dispensing at least one of an identification device and an article related to an event. The dispensing apparatus 300. The dispensing apparatus 300 may be similar in structure the dispensing apparatus 200. The dispensing apparatus 300 functions in substantially the same manner as the dispensing apparatus 100 or 200. Like features are denoted by like numbers.

Broadly speaking the dispensing apparatus 300 may comprise a storage unit 304 storing and allowing dispensing of an identification device, an input module configured to receive an input from a user, an electronic processor 330 in electronic communication with the input module 320, the electronic processor 330 processing the input and generating user data, the processor 330 also authenticating a user as an event participant based on at least the user data, an encoding module configured to encode the identification device with the user data to associate the identification device with the user and associate the identification device with the event, following successful authentication of the user as an event participant, and a dispenser 306 or a dispensing opening of the storage unit dispensing the encoded identification device from the storage unit 304 following encoding of the identification device. The input module 320 may include a reader 324 and/or a payment module 326 as well as a user interface 322.

The identification device may be any suitable electronic device such as an RFID tag, chip or label that is used to record a finish time or record both a start and finish time of the user, for an event. Alternatively the identification device may be any other suitable radio frequency based or electromagnetic radiation device such as RuBee tag, chip or label. In a further alternative form the identification device may be a wrist band with an optical code such as a QR code, or another article with an optical code on it. In a further example the identification device may be a scannable or readable optical code e.g. a barcode or a QR code that may be printed directly on one of the dispensed articles e.g. a race bib or shirt.

The articles may be race pack or a shirt or bib as described earlier. The race pack may a clothing item (e.g. a bib or a shirt or singlet), a headwear item (e.g. a hat or headband), a wearable device or any other suitable race event articles. The one or more articles may also comprise other articles related to any other event. The article(s) are preferably packaged. Alternatively the articles they may not be packaged. The race pack may also contain printed material such as advertising material and/or instructions or last minute weather or safety information for the user about the event. The race pack i.e. article may also include products such as energy gel packs or protein bars or promotional products or tokens or gifts or event sponsor related products. The race pack is stored in the storage unit 304 and dispensed to the user.

The dispensing apparatus 300 functions in substantially the same manner as dispensing apparatus 200 in that the apparatus 300 can encode an identification device to be associated with (i.e. linked) to a user, allow the user to receive the identification device, provide an article (e.g. a race pack) or present the article for collection by the user and may also print custom user information on an article.

The dispensing apparatus 300 also includes a printer 350 that is configured to print custom user information onto the article. The printer 350 may include an opening 352 that leads the dispenser 306. The dispenser 306 may be a tray or a trap door or a flap or a retrieval zone.

The dispensing apparatus 300 includes an openable door 360 positioned on the front or user facing side of the apparatus 300. A user interface 322 e.g. a touch screen or screen or combination of alphanumeric keypad and screen is disposed on the door 360 as shown in FIG. 5. The door 360 may extend the entire height of the dispensing apparatus or may only correspond to the height of the storage unit 304. The door 360 is preferably a hinged door that can hinge between an open and closed position. The door 360 also comprises a locking mechanism (not shown for clarity) that is configured to lock the door 360 in a closed position. The lock may be a mechanical or electro-mechanical lock. Preferably the lock is an electro-mechanical lock that can be controlled by the processor 330. The processor 330 is configured to unlock the door 360 once user has been authenticated and/or payment has been paid. The door 360 allows access to the storage unit 304, and the door 360 may function as a dispenser.

The storage unit 304 includes a plurality of receptacles 370 for retaining either identification devices and/or other articles (e.g. race packs). The receptacles function as compartments to hold and retain various items e.g. identification devices and/or articles such as race packs. Some of the receptacles 370 may be configured to retain identification devices e.g. RFID tags and some may be configured to retain other articles e.g. race packs. Some receptacles may be smaller in dimension e.g. in volume than other receptacles. For example receptacles to retain un-encoded and encoded identification devices (e.g. RFID tags) may be smaller in internal volume than receptacles configure to retain race packs. In the illustrated example of FIG. 5, the apparatus 300 comprises small receptacles 372 to retain identification devices and larger receptacles 374 to retain race packs or other articles.

In another form the storage unit 304 may comprise a separate compartment or one receptacle 370 is configured to retain the identification devices while the other receptacles 370 are configured to retain one or more articles e.g. race packs. The receptacles 370 are manually stocked by an appropriate person or official or technician. In a further example each receptacle may include a combination of an identification device and article positioned together. The user can open the door 360 once authenticated to access the identification devices and/or articles. The door 360 and receptacles 370 allow for easy access of identification devices and articles.

Each receptacle 370 may include an encoding module 340 associated with the receptacle. The encoding module 340 is preferably controller by the processor 330 and is configured to encode an identification device while it is in a receptacle 370. Alternatively there may be a single encoding module disposed in the storage unit 304. In one example the encoding module 340 may be housed within the processor 330. The processor 330 may be configured to identify the specific receptacle which is housing the encoded identification device for a particular user once the encoding is completed. Similarly the processor 330 may be configured to identify the specific receptacle housing the article or articles e.g. a race pack or shirt or bib that relates to the authenticated user. The receptacles 370 may also be numbered and the identity of the receptacle housing the user's identification device and article or articles may be displayed on the user interface 322. This is advantageous because it reduces the chances of a user taking the wrong identification device and/or articles.

The user can then open the door 360 and directly access the receptacle 370 housing his or her article or articles (e.g. a race pack) and encoded identification device (e.g. RFID tag). Alternatively the user may be able to open the door and access receptacles directly before the identification device has been encoded, however this is less desired.

The storage unit 304 may comprise a trap door or flap that allows at least the article or articles e.g. a shirt or bib to drop into the printer 350 for printing custom user information. Further printer 350 may provide the printed article to the dispenser 306 or may alternatively provide the printed article into an appropriate receptacle 370 for collection by the user via opening the door 360. The trap door opening or closing may be controlled by the processor 330. Alternatively the storage unit 304 may comprise a dispensing control mechanism that controls dispensing of identification devices and/or articles into the dispenser 306. In a further alternative configuration the storage unit 304 may be connected to the dispenser 306 by a tube or shoot or passageway (not shown). A trap door or dispensing control mechanism may be disposed within this passageway to control items dropping into the dispenser 306 from the storage unit 304 or one or more of the receptacles 370. The dispenser 306 may be a tray or retrieval zone or compartment or may be similar to dispenser 206, as described earlier.

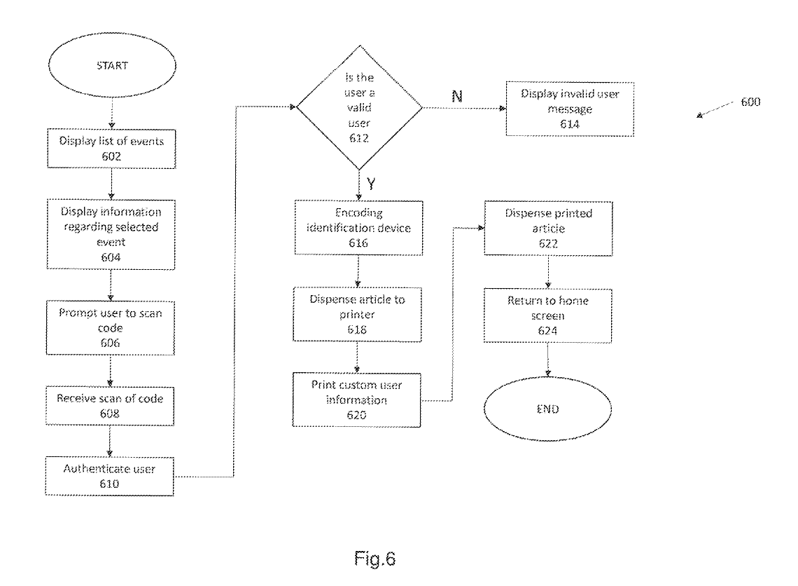

FIG. 6 shows an exemplary method 600 of dispensing an article. In particular FIG. 6 shows a flow chart of a method user interaction with a dispensing apparatus. The method 600 is preferably implemented and executed by a dispensing apparatus as described earlier. The method 600 describes a method of a user interacting with the dispensing article in order to receive an encoded identification device that is associated with the user and/or also receive one or more articles e.g. a race pack or a shirt or a bib or a wearable device or a wrist band or a headband or headwear etc.

Referring to FIG. 6, the method 600 commences at step 602. Step 602 comprises a user selecting an activity or event from a user interface of the dispensing apparatus. The dispensing apparatus is configured to present a list of events or activities. The list of events or activities corresponds to the events that have been loaded in the server 20 including event information for each event or activity. Step 604 comprises displaying information about the selected event or activity.

Step 606 comprises prompting the user to scan or input an ID or verification code e.g. an optical code such as QR code or barcode. The verification code may be provided to the user device 30 that can be scanned by a reader of the dispensing apparatus. Alternatively the user may print the verification code and scan the printed verification code.

Step 608 comprises receiving an input. In this example the input is a scan of a code e.g. a verification code from the user. The scan can be performed by the reader. Step 610 comprises processing the input to generate a user data and authenticate the user based on the identified user data. Step 610 comprises authenticating the user based on user data extracted from the input, by checking if the user data e.g. user name or race number corresponds with a registered user at the server 20. The dispensing apparatus, in particular the process is configured to communicate with the server 20 to authenticate the user. Step 612 comprises checking if the user is a valid user i.e. an authenticated user. If NO, the method proceeds to step 614 that comprises displaying an “invalid user” or equivalent message to the user on the screen of the dispensing apparatus. The user may also receive a notification on the user device regarding an invalid user.

If the check at step 612 results in a yes i.e. the user is a valid user the method proceeds to step 616. Step 616 comprises encoding an identification device with the user data to associate the identification device with the user. The identification device may be dispensed after encoding. Preferably method proceeds to step 618 that comprises dispensing an article e.g. a shirt or bib to a printer. The article is selected based on the user data for example the shirt or bib size is selected based on the user's size. Further additional articles such as snacks or protein bars or energy gels or promotional material or safety information or weather information may also be dispensed. These articles are preferably selected based on the selected event by the user and the articles are related to the selected event.

Step 620 comprises the printer printing custom user information e.g. a user race number or name or nickname on to the article if the article is a bib or shirt etc. Alternatively the printed information may be promotional or advertising information related to the event organiser or an event sponsor. Step 622 comprises dispensing the printed article bearing the custom information or promotional information. Step 624 comprises returning the screen of the dispensing apparatus to a home screen. The method ends at step 624 but returns to the start once another user approaches the dispensing apparatus.

The method may also comprise an additional optional step of requiring payment and executing an online payment process. The payment prompt may be presented to the user on the screen either before or after authentication. The payment can be executed via a payment module in the dispensing apparatus.

The various embodiments of the dispensing apparatus 100, 200 and 300 described herein are advantageous because they provide on location association and dispensing of an identification device for an event. This can alleviate the need for the user to register at the event or well in advance of the start event. Sometimes long registration queues exist at events that can be frustrating for competitors that need to physically and/or mentally prepare to compete. Further the dispensing apparatus may allow for on site payment for an event making it easier for users to sign up for events. The herein described dispensing apparatus is advantageous because it makes the process of collecting event relates articles (i.e. Identification devices and other articles) simpler, easier and less frustrating.

In addition, the provision of apparatus at multiple locations will make it convenient for participants to pick up their articles both distance to travel wise and time of pick up wise. They are not confined to one particular pick up location and/or time. The dispensing apparatus also provides on location association and dispensing of one or more other event related articles e.g. bibs shirts or food and drink articles to the user. The dispensing apparatus or machine, described herein, also help event organizers as they do not need large distribution teams to set up pick up a location of locations for event participants to pick up event related identification devices and articles. This has the advantage of reducing the cost of running the events and can make the distribution of the identification devices (e.g. RFID devices) and articles (e.g. t shirts or bibs). The present invention provides the advantage of dynamically allocating event (e.g. race) related materials and provides a more flexible approach for distributing event related materials.

The present invention provides a system, apparatus and method performing real-time assignment and dispensing of the RFID device (as well as other items associated with the race event) based on user input. With real-time assignment and dispensing of the RFID device, the possibility of human error is reduced and the user can also register for the race event on the actual day itself. The system can be adapted to cater for multiple events and dispense different articles for different events or for different users as participants of one event.

The dispensing apparatus as described herein is also advantageous because it allows a user to print custom user information on an article. The custom user information can be printed at the time of receiving an event related article thereby making it cheaper, easier and more accessible for a user to have custom information on their event article e.g. a nickname. Further the dispensing apparatus including a printer is also advantageous because event organisers are not required to gather requests for custom information and get these printed in advance, making the process cheaper for the event organisers and logistically simpler. The function of custom printing can also improve the participation levels for a particular event as users can customise their event related articles. Finally the dispensing apparatus including a printer is advantageous because an event organiser can easily and cheaply print promotional or advertising information on the articles thereby increasing their marketing reach or the reach of event sponsors. The process of printing promotional material becomes logistically simpler as the dispensing apparatus can print this information every time a user is authenticated, reducing the manpower and organisational costs that would be incurred by event organisers if these articles were required to be pre-printed.

There are several modifications or variations which may be made to one or more of the above described embodiments without departing from the scope of the invention. Although these modifications or variations have not been described, a person skilled in the art will be able to recognize and/or make such modifications or variations.

Preferred embodiments of the invention have been described by way of example only and modifications may be made thereto without departing from the scope of the invention.

1.-77. (canceled)

78. Dispensing apparatus for dispensing event related identification devices and other event related articles, the apparatus comprising:
a storage module configured to store event related identification devices and other event related articles;
an input module configured to receive user input;
a processing module having a processor in electronic communication with the input module, and configured to process the user input and generate user data based on the received user input;
an encoding module for encoding the generated user data onto at least one of the identification devices stored in the storage module so that that the encoded identification device is associated with a user for an event; and
one or more dispensing modules for dispensing the encoded identification device and at least one of the other articles stored in the storage module;
wherein the processing module is configured to match the at least one identification device with the at least one other article prior to dispensing of the encoded identification device and the at least one other article; and
the one or more dispensing modules is configured to dispense the encoded identification device and the least one other article as discrete articles.

79. The apparatus of claim 78, wherein the apparatus is a vending machine.

80. The apparatus according to claim 78, wherein the generated user data which is encoded onto the at least one identification device is a race number or some other data which uniquely identifies a user in a race event.

81. The apparatus according to claim 78, comprising:
a printer configured to receive custom user information from at least one of the processor module and the input module, and to print the custom user information on the at least one other article prior to dispensing the at least one other article.

82. The apparatus according to claim 81, wherein the one or more dispensing modules is configured to receive the at least one other article with custom user information printed thereon by the printer, and to dispense the at least one other article with custom user information printed thereon.

83. The apparatus according to claim 81, wherein the printer is configured to receive the at least one other article from the storage module prior to printing.

84. The apparatus according to claim 81, wherein the custom user information comprises at least one of a user's name, a user's nickname, a custom user name, a user's event number and a user's team name.

85. The apparatus according to claim 78, wherein the storage unit comprises a first receptacle for storing the event related identification devices.

86. The apparatus according to claim 85, wherein the storage unit comprises a second receptacle for storing the other event related articles, and the second receptacle and the first receptacle are separated from each other.

87. The apparatus according to claim 86, wherein the first receptacle and the second receptacle are each at least in part defined by a plurality of walls.

88. The apparatus according to claim 78, wherein the one or more dispensing modules includes one or more openings via which the encoded identification device and the at least one other article can be dispensed from the storage unit in order to allow a user to retrieve the encoded identification device and that at least one other article from the apparatus.

89. The apparatus according to claim 88, wherein the one or more dispensing modules comprises a closure, the closure moveable between a first position and a second position wherein the closure closes the opening(s) in the first position and the closure allows passage of the at least one identification device and/or the at least one other article from the storage unit to a retrieval zone via the opening(s) in the second position.

90. The apparatus according to claim 88, comprising:
a selection module arranged in electronic communication with the processor,
the selection module configured to select the at least on article from the storage unit based on the user data generated by the processor,
the selection module configured to provide the selected article(s) from the storage module to the opening(s) via which the at least one other article can be dispensed from the storage unit in order to allow a user to retrieve the identification device from the apparatus.

91. The apparatus according to claim 90, wherein the selection module is configured to select a textile garment that corresponds to a user size defined in the user data.

92. The apparatus according to claim 78, wherein the at least one identification device is a radio frequency identification (RFID) device.

93. The apparatus according to claim 92, wherein the RFID device is a RFID tag that is able to be encoded with event data related to an event and user data to associate the RFID tag with a user for an event.

94. The apparatus according to claim 78, wherein the identification device is used to track user performance in an event.

95. The apparatus according to claim 94, wherein the identification device is used as a timing device to track the time taken for the user to complete the event.

96. The apparatus according to claim 78, wherein the user data comprises at least one of a user name, user age, user shirt size, user shoe size or any other suitable user data.

97. The apparatus according to claim 78, wherein the at least one other article comprises a race pack including at least one of a clothing item, a headwear item and a wearable device.

98. The apparatus according to claim 97, wherein the clothing item is a bib or a shirt.

99. The apparatus according to claim 78, wherein the apparatus provides on location association of an identification device with a user for an event and dispensing of the identification device to the user.

100. The apparatus according to claim 99, wherein the apparatus provides on location association of the at least one other article with the user for an event and dispensing of the at least one other article to the user.

101. The apparatus according to claim 78, comprising:
a payment module configured to connect to an electronic gateway such that a user can execute an electronic payment for an event at the payment module.

102. The apparatus according to claim 78, wherein the input module comprises a user interface configured to present a list of one or more events to a user, and the input module is configured to receive via the user interface a selection of an event from a user.

103. A system for dispensing event related identification devices and other event related articles, the system comprising:
at least one dispensing apparatus according to claim 78;
an event server arranged in electronic communication with the processing module, the event server storing event information;
wherein one of the processing module and the event server is configured to authenticate a user as a participant of an event by comparing the user data with the stored event information.

104. The system according to claim 103, wherein the processing module or the event server is configured to authenticate the user as an event participant, if the user data matches the stored event information.

105. The system according to claim 103, wherein the event information comprises at least one of an event date, an event name, registered participant information, and an event type.

106. The system according to claim 103, wherein the user is authenticated by checking if a user name corresponds to the registered participant information.

107. The system according to claim 103, wherein the input module comprises at least one of a screen, and a reader for reading and/or a scanner for scanning at least one of a code, a Near Field communication device, an EID (such as an RFID), and a physiological feature.

108. The system according to claim 107, wherein the reader is adapted to scan a code to receive scan data;
the processor is configured to extract the user data from the received scan data and to communicate with the event server after extracting the user data;
the processor or the event server is configured to authenticate the user as an event participant based on the user data and the stored event information.

109. The system according to claim 103, wherein the encoding module is configured to encode the identification device with the user data, to associate the identification device with the user and an event, following successful authentication of the user as an event participant.

110. The system according to claim 103, wherein the one or more dispensing modules is configured to dispense the encoded identification device and the at least one other article following successful authentication of the user as an event participant.

111. The system according to claim 110, wherein the one or more dispensing modules is configured to simultaneously dispense the identification device and the at least one other article following successful authentication of a user as an event participant.

112. The system according to claim 103, wherein the input module is configured so that a user can perform a registration process, and the processing module is configured to transmit registration information to the event server.

113. The system according to claim 103, wherein the event server comprises an event database that stores the event information.

114. The system according to claim 113, wherein the event server is configured to extract event information from the event database and provide the event information to the processor for authentication of the user.

115. The system according to claim 103, wherein the system comprises a plurality of the dispensing apparatus.

116. The system according to claim 115, wherein the plurality of the dispensing apparatus are geographically separated such that each dispensing apparatus is located at a separate geographical location as compared to the other dispensing apparatus(es).

117. A method for dispensing at least one identification device and at least one other article from dispensing apparatus, the method comprising:
a dispensing apparatus storing one or more identification devices and one or more other articles, the stored one or more identification devices and one or more other articles being related to an event;
the dispensing apparatus receiving an input from a user;
the dispensing apparatus processing the input to generate user data;
authenticating the user as a participant of the event;
the dispensing apparatus encoding at least one of the identification devices with the user data following successful authentication;
the dispensing apparatus matching the at least one identification device and at least one of the other articles; and
the dispensing apparatus dispensing the encoded identification device and the at least one other article as discrete articles, following successful authentication of the user.

118. The method according to claim 117, wherein the dispensing apparatus storing one or more identification devices and one or more of the other articles comprises the dispensing apparatus storing a plurality of identification devices and a plurality of other articles.

119. The method according to claim 117, comprising:
printing custom user information onto the at least one other article, and
dispensing the at least one other article with the custom user information printed thereon.

120. The method according to claim 119, wherein the custom user information comprises at least one of a user's name, a user's nickname, a custom user name, a user's event number and a user's team name.

121. The method according to claim 117, comprising:
communicating with an event server that stores event information,
authenticating a user as a participant of the event by comparing the user data with the stored event information.

122. The method according to claim 121, wherein a user is authenticated as an event participant if the user data matches the stored event information.

123. The method according to claim 118, wherein the event information comprises one or more of an event date, event name, participant information and event type.

124. The method according to claim 118, comprising registering a user as a participant and transmitting the participant information to the event server.

125. The method according to claim 118, comprising:
scanning a user identifier and generating the input.

126. The method according to claim 118, comprising:
connecting to an electronic gateway,
executing an electronic payment for an event at a payment module.

127. The method according to claim 118, comprising the steps of presenting a list of one or more events available for participation by a user, and receiving an event selection from the user of at least one of the one or more events.

128. The method according to claim 127, comprising the step of authenticating a user as an event participant for the selected event.

129. The method according to claim 127, comprising the steps of encoding the at least one identification device with the user data such that the identification device is linked to a user and linked to the selected event.

130. The method according to claim 118, wherein the at least one identification device is an RFID (radio frequency identification) device that is used to track user performance in an event.

131. The method according to claim 118, wherein the user data comprises at least one of a user name, user age, user shirt size, user shoe size or any other suitable user data.

132. The method according to claim 118, wherein the one or more articles comprises a race pack including one or more of a clothing item, a headwear item, a wearable device.

133. The method according to claim 118, wherein the method provides on location association of the at least one identification device with a user for an event and dispensing of the at least one identification device to the user.

134. The method according to claim 133, wherein the method provides on location association of the at least one other article with the user for an event and dispensing of the at least one other article to the user.
